(19) United States
(12) Patent Application Publication
(10) Pub. No.: US 2024/0131627 A1
(43) Pub. Date: Apr. 25, 2024

(54) LASER BEAM JOINING METHOD

(71) Applicant: AUDI AG, Ingolstadt (DE)

(72) Inventors: Markus GRETZER, Eichstätt (DE); Jan-Philipp WEBERPALS, Abstatt (DE)

(73) Assignee: AUDI AG, Ingolstadt (DE)

(21) Appl. No.: 18/546,645

(22) PCT Filed: Apr. 20, 2022
(86) PCT No.: PCT/EP2022/060474

§ 371 Date: Aug. 15, 2023

(30) Foreign Application Priority Data
Apr. 21, 2021 (DE) 10 2021 110 241.3

(51) Int. Cl. B23K 26/244

(52) U.S. Cl. CPC B23K 26/244

(57) ABSTRACT

A method for laser beam joining of at least two joining partners, in which a laser beam device produces a continuous weld seam along an application path with a preferably very long path length. Irregularities in the weld seam due to high process speeds are avoided as follows: in a first process step, at least two weld seam sections spaced apart from one another in the longitudinal direction of the path, are respectively produced with an intermediate weld seam interruption. In a second process step the laser beam device produces in each weld seam interruption a further weld seam section, such that all weld seam sections merge together without interruptions, in particular with formation of the continuous weld seam.

### FIELD

The invention relates to a laser beam joining method.

### BACKGROUND

For example, bipolar plates of a fuel cell can be manufactured from a composite of two sheet metal parts that have a very thin material thickness. In preparation for the welding process, the sheet metal parts are placed one on top of the other and connected to one another by laser beam joining. The weld seams formed can extend over a length of several meters.

In a generic method for laser beam joining of at least two joining partners, a laser beam device produces a continuous, uninterrupted weld seam along a predefined application path.

In the case of laser beam joining known from the prior art, the laser beam moves continuously along the application path at a process speed, as a result of which the weld seam is formed. At a process speed above a critical limit value as well as depending on other process parameters and the physical and geometric material properties, periodic irregularities in the course of the weld seam occur after a welding process start phase. This effect is called humping because it takes on a structure of beads or small clusters. In such a weld structure, material accumulations and material deficits periodically form, which lead to a weakening of the welded connection and thus to a higher probability of a leak. Accordingly, in the prior art, the critical process speed limit above which this effect occurs represents a process limitation.

Against this background, in the prior art, the process speeds during laser beam joining cannot be scaled up arbitrarily in order to produce a uniformly strong weld seam connection. The regulation due to the occurrence of irregularities (humping) sets limits to scaling, since the functionality of the connection is reduced as a result (such as leakage when gas-tightness is required for bipolar plates due to partial material deficit). Due to the limited process speed, the number of welding systems must be increased in large-scale production. In addition, in the prior art there is a high risk of rejects or an additional expense resulting from component distortion due to heat input caused by welding.

To date, there is no large-scale production system that requires such a process speed. With the previous concepts, a very large number of systems and devices with associated high investment volume is necessary in order to achieve the required quantities. The increase in process speed is directly related to the reduction in cycle time and thus productivity.

Due to the process limits described above, the process speed cannot currently be further increased by adjusting the process parameters. Current speeds in laser beam deep welding of sheet steel, for example, amount to values in the range of 1 m/s, which in the case of thin foils leads to irregularities in the seam surface and leaks in the weld seam.

A method and a device for pulsed high-energy welding are known from EP 0 143 450 Bl. From U.S. Pat. No. 5,595,670 A a method for high-speed welding is known. DE 10 2019 006 217 A1 discloses a method for connecting at least two workpieces by means of a laser beam.

### SUMMARY

The object of the invention is to provide a method for laser beam joining in which the process speed can be increased compared to the prior art and wherein at the same time periodic irregularities in the course of the weld seam can be avoided.

The invention is based on a method for laser beam joining of at least two joining partners, in which a laser beam device produces a continuous weld seam along an application path with a preferably very long path length.

The invention is based on the following finding: in conventional laser beam joining, the laser beam moves continuously along the application path at a process speed, as a result of which the continuous weld seam is produced. Especially at a process speed above a critical limit value, periodic irregularities with material accumulations and material deficits occur after a welding process start phase. In the prior art, therefore, the weld seam produced in the start phase of the welding process is still flawless, while the weld seam produced in the further course of the welding process is afflicted with periodic irregularities. Against this background, according to the characterizing part of claim 1, the weld seam is not produced continuously over the entire length of the application path. Rather, the method according to the invention for avoiding irregularities in the weld seam due to excessive process speeds has two process steps: in the first process step, at least two weld seam sections that are spatially distant from one another in the length of the application path over a weld seam distance are produced with an intermediate weld seam interruption. In the second process step, another weld seam section is created in the weld seam interruption, so that the weld seam sections merge into one another without any interruptions, as a result of which the continuous weld seam is formed.

It should be emphasized that the method according to the invention is not limited to laser beam joining of two joining partners. Rather, the method according to the invention is also suitable for the production of a composite component from a plurality of joining partners. It should also be emphasized that the method according to the invention can be used independently of the material thickness. This means that the process can cover both applications with thicker materials, for example in body construction, and applications with thinner materials, for example approx. 50 μm to 200 μm, as those that occur in laser beam joining of electrochemical components of an electrochemical system, for example bipolar plates of a fuel cell, battery cell components or components of a battery module, an overall battery system, an electrolyzer, a hydrogen compressor and the like. The idea is based on the idea of creating a joining process using laser beam welding, which enables a high process speed and yet reliably avoids the occurrence of humping in the weld seam to be produced. The implementation concept is characterized by the fact that a long, continuous and also gas-tight weld seam to be created is gradually assembled from a large number of weld seam sections. The aim is that the individual weld seam sections can be joined at a significantly higher process speed than a long continuous seam.

The idea is that at the beginning of a weld seam, the welding process develops depending on the process parameters—primarily the process speed—and the physical and geometric material properties of the welding process. During this start phase, in addition to the melting of the components, the flow fields around the capillary and in the resulting melt pool must first build up. In this start phase, the periodic formation of humps does not occur. The length of this start phase corresponds to the length of the individual weld sections. It depends on the process parameters and is largely dependent on the process speed.

As a result, the process speed with regard to the weld seam sections can be significantly increased. Laser optics used in laser beam welding can precisely align the laser beam between two weld seam sections (end of seam section 1 to start of seam section 2) in the millisecond range. This makes it possible to successively produce weld seam sections that are spatially distant from one another without any significant loss of time. Depending on the strategy for the sequential order of the individual weld seam sections, these are preferably carried out in an overlapping manner so that a continuous, materially bonded and gas-tight connection is created between the weld seam sections. In order to ensure the reliability of the tightness between the weld seam sections, the overlapping of the two weld seam sections can be designed as crossing or intersecting path geometries in addition to an overlapping line-up. The length of the region to be overlapped is determined by the process-relevant parameters and the physical and geometric material properties. In addition, the strategy for the spatial generation of weld seams can be determined by process control through the laser optics (such as a large field scanner with gravimetrically driven mirrors). Conceivable are, for example, adjacent weld seam sections placed one after the other (example sequence: 1, 3, 2, 5, 4, 7, 6, etc. or first even sections followed by odd sections), seam nests, the parallelization of weld seams or alternate build-up. The resulting heat field can also be influenced in this way and the resulting thermal distortion can be kept low or controlled.

The main technical benefit of the invention consists in increasing the process speed in laser beam joining of materials in order to avoid the humping effect by dividing the weld seam into weld seam sections.

Relevant aspects of the invention are highlighted again in detail below: it is thus preferred if the length of the respective weld seam section is less than or equal to the start phase length of the weld seam produced in conventional laser beam joining. The length of the respective weld section can therefore be determined in a series of tests in which the start phase length of the weld is determined in a comparative welding process.

In a technical implementation, in order to increase the tightness of the weld seam, adjacent weld sections can merge into one another with an overlap.

In a first embodiment variant, all of the weld seam sections can be aligned completely in longitudinal alignment with the application path. In this case, the weld seam end of one weld seam section can overlap with the weld seam beginning of the adjacent weld seam section in the overlapping region.

As an alternative to this, the weld seam overlap can be implemented as follows: the adjacent weld seam sections can have overlapping sections that are positioned at an angle to one another. The overlapping sections may cross or intersect at an overlap point.

The finished weld seam can be subdivided, starting with a first edge-side weld seam section with increasing numbering, into a second, third, fourth and further weld seam sections. The weld seam sections can be placed according to different strategies within the scope of the invention: for example, in a laser beam joining process in a lateral process sequence, initially the first, then the third, then the second, the fifth, the fourth, the seventh, etc. weld section are generated. In an alternative welding strategy, in one of the two process steps (for example the first process step) the weld seam sections with even numbering can initially be produced. In the other process step (such as the second process step), the odd-numbered weld sections can then be produced.

According to the invention, the laser beam joining is implemented in particular as deep laser beam welding, in which sheet metal parts lying one on top of the other and preferably having an extremely thin material thickness are connected to one another as joining partners. The material thickness can be in the range of 75 μm, for example. However, it should be emphasized that the invention is not only limited to thin material thicknesses, but can be used with any material thickness and/or shape of the joining partners.

The method can be used in particular for laser beam joining of components in an electrochemical system, such as battery cell components, or for components of a battery module, an overall battery system, a fuel cell, an electrolyzer, a hydrogen compressor or the like. In this case, sheet metal parts lying one on top of the other with a material thickness in the range of, for example, 50 μm to 250 μm, or in the range of, for example, 250 μm to 500 μm, can be connected to one another. As an alternative, other applications are also possible, for example in laser beam joining of superimposed sheet metal parts with a material thickness in the range of, for example, 250 μm to 500 μm. The method can also be used for laser beam joining of components in body construction. In this case, sheet metal parts lying one on top of the other with a material thickness of, for example, greater than 0.5 mm, in particular in the range from 0.5 mm to 5 mm, particularly preferably in the range from 0.5 mm to 3 mm, can be connected to one another as joining partners.

### BRIEF DESCRIPTION OF THE FIGURES

Exemplary embodiments of the invention are described in the following on the basis of the appended figures.

In the figures:

FIG. 1 shows a completed welded connection according to the invention in a first view;

FIG. 2 shows a completed welded connection according to the invention in a second view;

FIG. 3 shows a view which illustrate the laser beam joining according to the invention;

FIG. 4 shows a view which illustrate the laser beam joining according to the invention;

FIG. 5 shows a view, on the basis of which a weld seam produced in a comparative welding process is illustrated;

FIG. 6 shows a view, on the basis of which a weld seam produced in a comparative welding process is illustrated; and

FIG. 7 shows a welded seam connection according to a second exemplary embodiment of the invention.

### DETAILED DESCRIPTION

The method according to the invention allows the production of a component composite of two or more sheet metal parts. In principle, the method can be used regardless of the material thickness. This means that in addition to an application, for example in body construction, applications with thin material thicknesses in the range of, for example, approx. 50 μm to 200 μm are also possible, as they occur with electrochemical components, for example bipolar plates in a fuel cell; Battery cell components, components of a battery module or overall battery system, an electrolyzer, a hydrogen compressor or the like.

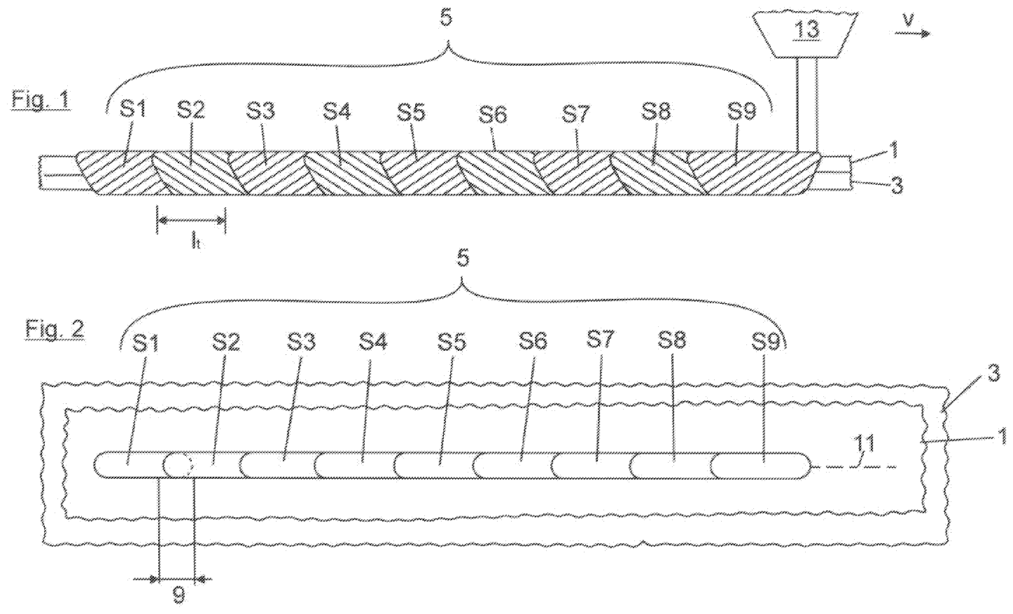

In FIGS. 1 and 2, a welded joint between two superimposed sheet metal parts 1, 3 is shown. The two sheet metal parts 1, 3 have extremely thin material thicknesses of 75 μm, for example. The sheet metal parts 1, 3 are, for example, components of an electrochemical system, such as a battery cell or a fuel cell, a battery module or an overall battery system.

It should be emphasized that the invention is not limited to the material thickness of 75 μm specified above. Rather, the superimposed sheet metal parts 1, 3 can also have a material thickness in particular in the range of, for example, 50 μm to 250 μm, or in the range of, for example, 250 μm to 500 μm. As an alternative to this, other applications are also possible, for example in the laser beam joining of superimposed sheet metal parts with a material thickness in the range of, for example, 250 μm to 500 μm.

In addition, the method is not limited to the laser beam joining of components of an electrochemical system. Rather, the method can be used in any application, for example in laser beam joining of components in body construction. In this case, superimposed sheet metal parts 1, 3 with a material thickness of, for example, greater than 0.5 mm, in particular in the range from 0.5 mm to 5 mm, particularly preferably in the range from 0.5 mm to 3 mm, can be connected to one another as joining partners.

In the exemplary embodiment of FIGS. 1 and 2, the two sheet metal parts 1, 3 are connected to one another via a straight weld seam 5, which extends along an application path 11 indicated by dot-dash lines. The weld seam 5 is produced by means of a laser beam joining method, which will be described later and is implemented specifically as a laser beam deep welding.

As can also be seen from FIGS. 1 and 2, the weld seam 5 is continuous, that is to say without interruption. The weld seam 5 is divided in FIGS. 1 and 2 into individual weld seam sections S1 to S9, beginning with a first edge-side weld seam section S1, with ascending numbering, into a second to ninth weld seam section S2 to S9. Adjacent weld sections S1 to S9 merge into one another with an overlap 9. In FIGS. 1 and 2, all weld seam sections S1 to S9 are aligned in longitudinal alignment with the application path 11, along which a laser beam head 13 of a laser beam device is guided at a process speed v in the joining process. In the overlapping regions 9, the weld seam end of one weld seam section S1 to S9 overlaps the weld seam beginning of the adjacent weld seam section S1 to S9.

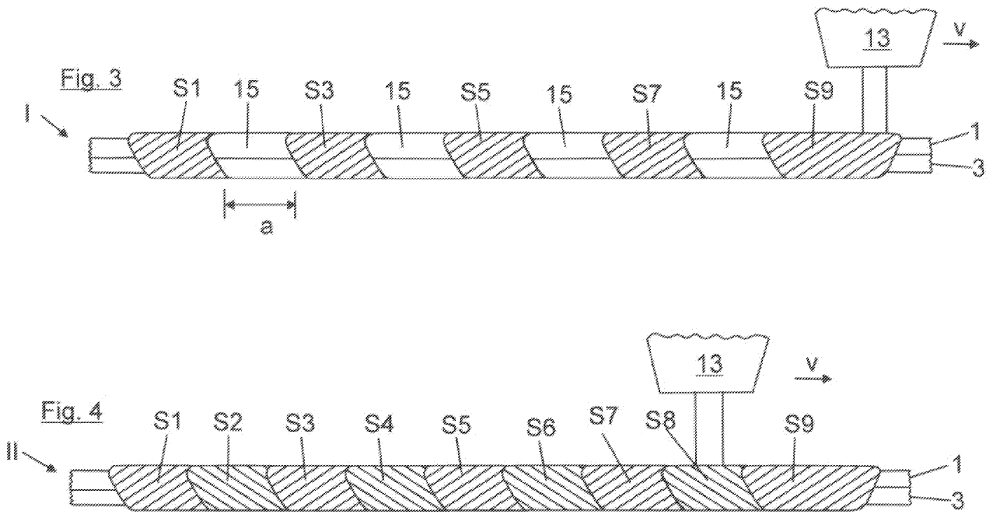

The laser beam joining according to the invention for producing the weld seam 5 shown in FIGS. 1 and 2 is described below with reference to FIGS. 3 and 4: accordingly, the method has a first process step I (FIG. 3) and a second process step II (FIG. 4). In the first process step I, the odd-numbered weld seam sections S1, S3, S5, S7, S9 are produced spatially spaced apart from one another by a weld seam distance a along the path length of the application path 11 with a respective intermediate weld seam interruption 15. In the second process step II (FIG. 4), the laser beam device produces the even-numbered weld seam sections S2, S4, S6, S8 in the respective weld seam interruptions 15. After completion of the second process step II, all weld seam sections S1 to S9 therefore merge into one another without interruption, specifically with the formation of the continuous weld seam 5.

As an alternative to FIGS. 3 and 4, any other welding strategy can be used within the scope of the invention. For example, the first, then the third, then the second and then the fifth weld seam section and following can be produced in a chronological process sequence in laser beam joining. Irrespective of this, the weld seam sections S1 to S9 can be placed in any sequence within the scope of the invention. The welding sequence can be designed, particularly in the case of joining partners with a low material thickness, in such a way that thermal component distortion that occurs during the welding process is avoided.

Furthermore, the invention is not limited to the number of weld seam sections shown in the figures. Rather, the invention is applicable to any number of weld seam sections. Likewise, the weld seam is not limited to the linear course of the weld seam shown in the figures. Rather, the weld seam and/or the weld seam sections can be realized in any free form, for example curved, circular, rectangular or the like.

The essence of the invention is the knowledge that in conventional laser beam joining, in which the laser beam head 13 is guided along the application path 11 at a continuous process speed v, the following problem arises: at a process speed v above a critical limit value, after a welding process start phase, periodic irregularities occur with material accumulations 17 and material deficits 19. Correspondingly, the weld seam 21 (FIG. 5) produced in the welding process start phase is still flawless, while the humping effect occurs as the welding process proceeds, namely the weld seam produced in the further course of the welding process 23 (FIG. 5) is afflicted with periodic irregularities 17, 19.

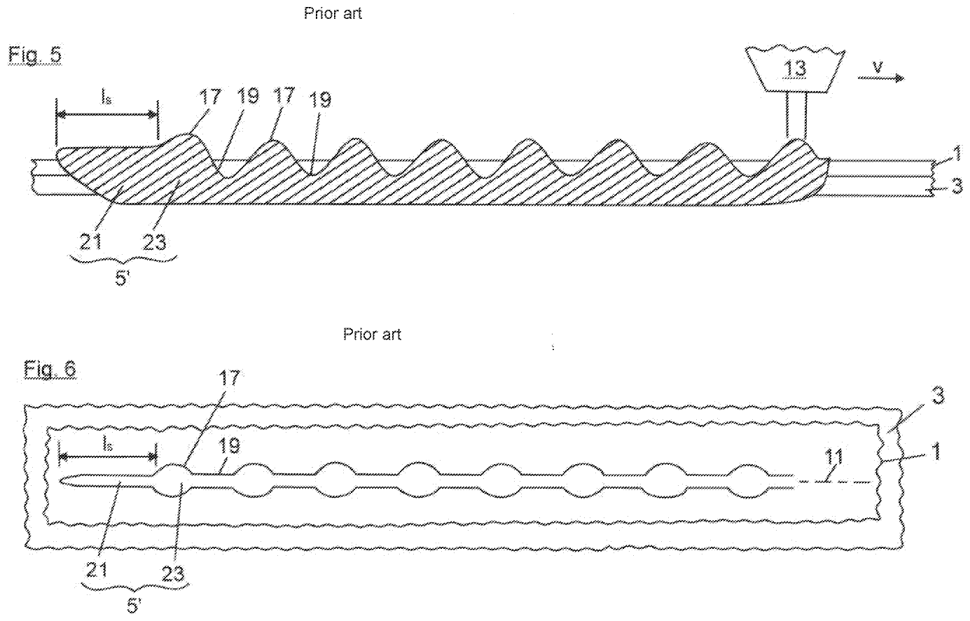

In order to avoid the humping effect in the weld seam 5 according to the invention, a comparative laser beam joining indicated in FIGS. 5 and 6 is first carried out in a series of tests. In the comparative laser beam joining (FIGS. 5 and 6) and in the laser beam joining according to the invention (FIGS. 1, 2, 3 and 4), the process speeds v are selected to be identical. In contrast to the invention, in a comparative laser beam joining, the laser beam head 13 is guided along the application path 11 at a continuous process speed v. After the comparative laser beam joining has taken place, the start phase length is of the start phase weld seam 21 produced in the comparative laser beam joining is determined. The length I t of the respective weld seam section S1 to S9 is dimensioned to be less than or equal to the start phase length lₛ of the start phase weld seam 21 produced in the comparative laser beam joining.

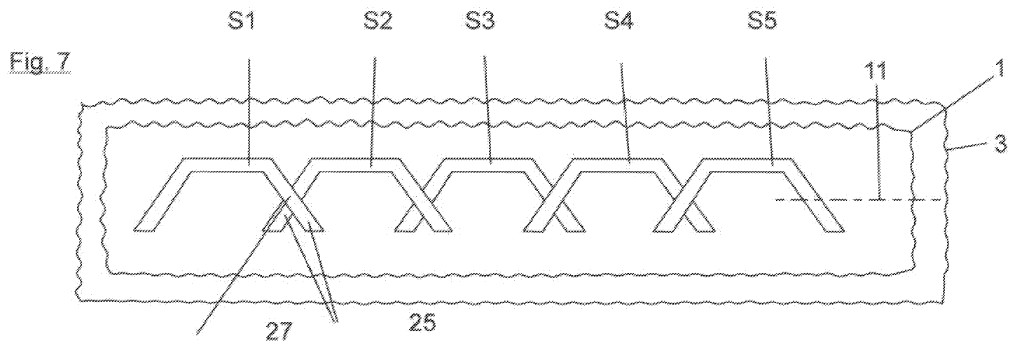

FIG. 7 shows a weld seam geometry according to a second exemplary embodiment. Accordingly, the weld seam sections S1 to S5 are not completely aligned in longitudinal alignment with the application path 11. Rather, the adjacent weld seam sections S1 to S5 each have overlapping sections 25 that are inclined relative to one another. These cross or intersect at an overlap point 27 in order to produce a gas-tight weld seam 5.

### LIST OF REFERENCE NUMERALS

1, 3 joining partner
5 weld seam
5′ comparative weld seam
9 overlap
11 application path
13 laser beam head of a laser beam device
15 weld seam interruption
17 material accumulations
19 material deficits
21 start phase weld seam
23 weld seam
a weld seam distance
lₛ length of start phase weld seam
lₜ length of weld seam sections
S1 to S9 weld seam sections
v process speed
I, II process steps

1-10. (canceled)

11. A method for laser beam joining of at least two joining partners, in which a laser beam device produces a continuous weld seam along an application path with a preferably very long path length, wherein in order to avoid irregularities in the weld seam due to high process speeds, the method comprising:
a first process step, in which at least two weld seam sections spaced apart from one another in the longitudinal path direction are produced, each with an inter-mediate weld seam interruption, and
a second process step, in which the laser beam device produces a further weld seam section in each weld seam interruption, so that all weld seam sections merge into one another without interruption, in particular with the formation of the continuous weld seam.

12. The method according to claim 11, wherein, in order to increase the weld seam tightness, adjacent weld seam sections merge into one another with an overlap.

13. The method according to claim 11, wherein all weld seam sections are aligned in longitudinal alignment with the application path, and in that, in particular in the overlapping region, the weld seam end of one weld seam section over-laps the beginning of the weld seam of the adjacent weld seam section.

14. The method according to claim 12, wherein for the weld seam overlap, the adjacent weld seam sections have overlapping sections which are inclined relative to one another and which cross or intersect one another at an overlap point.

15. The method according to claim 11, wherein the finished weld seam, starting with an edge-side first weld seam section, can be divided with ascending numbering into a second, third, fourth and following weld seam section, and in that, in particular in the laser beam joining process, the first, third, second, fifth, fourth, seventh, etc. weld seam section are generated according to a chronological process sequence.

16. The method according to claim 15, wherein, in the laser beam joining process, in a process step, for example the first process step, the odd-numbered weld seam sections are initially produced, and in another process step, for example the second process step, the even-numbered weld seam sections are produced.

17. The method according to claim 11, wherein, by moving the laser beam de-vice at a process speed along the application path in a particularly conventional comparative laser beam joining, in particular by forming a comparative weld seam, and in particular at a process speed above a critical limit value after a welding process start phase, periodic irregularities with material accumulations and mate-rial deficits occur, so that the start phase weld seam produced in the welding process start phase is still flawless, while the weld seam produced in the subsequent welding process is subject to the periodic irregularities.

18. The method according to claim 17, wherein the length of the respective weld section in the weld seam is less than or equal to the start phase length of the weld seam produced by comparative laser beam joining.

19. The method according to claim 11, wherein the laser beam joining is implemented as a laser beam deep welding, in which sheet metal parts which are superimposed as joining partners are connected to each other with a material thickness in particular in the range of, for example, 50 μm to 250 μm, preferably 75 μm, or in the range of, for example, 250 μm to 500 μm.

20. The method according to claim 11, wherein the laser beam joining is implemented as a laser beam deep welding, in which sheet metal parts which are superimposed as joining partners are connected to each other with a material thickness in particular greater than 0.5 mm, in particular in the range of 0.5 mm to 5 mm, particularly preferably in the range of 0.5 mm to 3 mm.

21. The method according to claim 12, wherein all weld seam sections are aligned in longitudinal alignment with the application path, and in that, in particular in the overlapping region, the weld seam end of one weld seam section over-laps the beginning of the weld seam of the adjacent weld seam section.

22. The method according to claim 12, wherein the finished weld seam, starting with an edge-side first weld seam section, can be divided with ascending numbering into a second, third, fourth and following weld seam section, and in that, in particular in the laser beam joining process, the first, third, second, fifth, fourth, seventh, etc. weld seam section are generated according to a chronological process sequence.

23. The method according to claim 13, wherein the finished weld seam, starting with an edge-side first weld seam section, can be divided with ascending numbering into a second, third, fourth and following weld seam section, and in that, in particular in the laser beam joining process, the first, third, second, fifth, fourth, seventh, etc. weld seam section are generated according to a chronological process sequence.

24. The method according to claim 14, wherein the finished weld seam, starting with an edge-side first weld seam section, can be divided with ascending numbering into a second, third, fourth and following weld seam section, and in that, in particular in the laser beam joining process, the first, third, second, fifth, fourth, seventh, etc. weld seam section are generated according to a chronological process sequence.

25. The method according to claim 12, wherein, by moving the laser beam device at a process speed along the application path in a particularly conventional comparative laser beam joining, in particular by forming a comparative weld seam, and in particular at a process speed above a critical limit value after a welding process start phase, periodic irregularities with material accumulations and material deficits occur, so that the start phase weld seam produced in the welding process start phase is still flawless, while the weld seam produced in the subsequent welding process is subject to the periodic irregularities.

26. The method according to claim 13, wherein, by moving the laser beam device at a process speed along the application path in a particularly conventional comparative laser beam joining, in particular by forming a comparative weld seam, and in particular at a process speed above a critical limit value after a welding process start phase, periodic irregularities with material accumulations and material deficits occur, so that the start phase weld seam produced in the welding process start phase is still flawless, while the weld seam produced in the subsequent welding process is subject to the periodic irregularities.

27. The method according to claim 14, wherein, by moving the laser beam device at a process speed along the application path in a particularly conventional comparative laser beam joining, in particular by forming a comparative weld seam, and in particular at a process speed above a critical limit value after a welding process start phase, periodic irregularities with material accumulations and material deficits occur, so that the start phase weld seam produced in the welding process start phase is still flawless, while the weld seam produced in the subsequent welding process is subject to the periodic irregularities.

28. The method according to claim 15, wherein, by moving the laser beam device at a process speed along the application path in a particularly conventional comparative laser beam joining, in particular by forming a comparative weld seam, and in particular at a process speed above a critical limit value after a welding process start phase, periodic irregularities with material accumulations and material deficits occur, so that the start phase weld seam produced in the welding process start phase is still flawless, while the weld seam produced in the subsequent welding process is subject to the periodic irregularities.

29. The method according to claim 16, wherein, by moving the laser beam device at a process speed along the application path in a particularly conventional comparative laser beam joining, in particular by forming a comparative weld seam, and in particular at a process speed above a critical limit value after a welding process start phase, periodic irregularities with material accumulations and material deficits occur, so that the start phase weld seam produced in the welding process start phase is still flawless, while the weld seam produced in the subsequent welding process is subject to the periodic irregularities.

30. The method according to claim 12, wherein the laser beam joining is implemented as a laser beam deep welding, in which sheet metal parts which are superimposed as joining partners are connected to each other with a material thick-ness in particular in the range of, for example, 50 μm to 250 μm, preferably 75 μm, or in the range of, for example, 250 μm to 500 μm.
